(19) United States
(12) Patent Application Publication
(10) Pub. No.: US 2003/0029064 A1
(43) Pub. Date: Feb. 13, 2003

(54) Emergency signage

(76) Inventors: Lorraine A. Gordon, Baltimore, MD (US); Craig A. Hall, Parkville, MD (US); Bruce L. Robinson, Baltimore, MD (US); Catherine D. Hall, Parkville, MD (US)

Correspondence Address: LARRY J. GUFFEY, WORLD TRADE CENER - SUITE 1800, 401 EAST PRATT STREET, BALTIMORE, MD, 21202, US

(21) Appl. No.: 10/255,982

(22) Filed: Sep. 26, 2002

(51) Int. Cl. G09F 11/00; G09F 9/00

(52) U.S. Cl. 40/491; 116/321

(57) ABSTRACT

A placard apparatus is disclosed which can be displayed in the window of a room to visually inform responding emergency personnel as to the occupancy status and the circumstances existent with the room. This placard apparatus comprises: (a) a top member having a right and a left edge with an opening proximate in each these edges, and a central section having thereon identifying indicia, (b) a spacer member having a central section containing an opening bounded in part by a pair of parallel edges, (c) a slidably movable signage member configured so as to fit between the pair of parallel edges of the spacer member opening and beneath the central section of the top member, with this signage member having right and left portions with indicia indicating either safe or unsafe conditions within the room, (d) a back member having a right and a left edge and a slotted opening extending between these edges, with this back member being positioned behind the spacer and signage members, and (e) means for fastening these members together. One operates this placard by sliding the signage member sideways to position the appropriate side indicating the room's safety status so that it is visible in one of the top member's openings.

### BACKGROUND OF THE INVENTION

1. Field of Invention

The present invention generally relates to sign exhibiting materials, and to printed matter having revealable, concealed identifying information. More particularly, this invention relates to a placard apparatus for display in the window of a room for visually informing responding emergency personnel as to the safety status of the occupants in the room where the placard apparatus is displayed.

2. Description of the Related Art

A placard devices has previously been proposed for communicating information regarding the occupancy status and circumstances existent within a household residence to emergency personnel responding to calls for assistance. See U.S. Pat. No. 5,683,114. However, a problem with this device is that it is not well suited for use in a multi-room building where the occupancy and safety status existent within each of the rooms in the building needs to be quickly communicated to the responding emergency personnel.

The need for such a signage device has become clearly evident with the recent rash of hostage situations that have occurred within school buildings and various workplaces around the world. The applicant herein, by her invention teaches a system and method which provides both new and novel approaches to quickly and efficiently effect the imparting of information on the occupancy status and circumstances existent within each room of a multi-room building at the time of a call response by emergency personnel.

3. Objects and Advantages

There has been summarized above, rather broadly, the prior art that is related to the present invention in order that the context of the present invention may be better understood and appreciated. In this regard, it is instructive to also consider the objects and advantages of the present invention.

It is an object of the present invention to provide a placard apparatus for display in the window of a room for visually informing responding emergency personnel as to the occupancy status and circumstances existent within the room where the placard apparatus is displayed.

It is another object of the present invention to provide a method for visually informing responding emergency personnel as to the occupancy status and circumstances existent within each room of a multi-room building.

It is still another object of the present invention to provide a placard apparatus that can be displayed in each of the windows of a multi-room building so as to visually inform responding emergency personnel as to the occupancy status and circumstances existent within the building's various rooms.

It is a further object of the present invention to provide an emergency communication system that will better enable emergency personnel to respond to the circumstances existent within each room of a multi-room building.

These and other objects and advantages of the present invention will become readily apparent as the invention is better understood by reference to the accompanying drawings and the detailed description that follows.

### SUMMARY OF THE INVENTION

In accordance with one preferred embodiment of the present invention, a placard apparatus for display in the window of a room for visually informing responding emergency personnel as to the occupancy status and circumstances in the room where the placard apparatus is displayed comprises: (a) a top, planar member having a right and a left edge with an opening proximate each of these edges and a central section with indicia thereon that separates the openings, (b) a middle, planar spacer member having a central section containing an opening which has a pair of parallel edges, (c) a slidably movable, planar, signage member configured so as to fit between the pair of parallel edges of the spacer member opening and beneath the central section of the top, planar member, with this signage member having a right side and a left side portion containing identifying indicia, (d) a back, planar member having a right and a left edge and a slotted opening extending between these edges, with the back member being positioned behind the spacer and signage members, and (e) means for fastening the members together so that the front members lies on top of the spacer member which lies on top of the back member and with the signage member lying within the cavity formed by the opening in the middle spacer member and the outer surfaces of the front and back members. One operates this placard by sliding the signage member sideways to position the appropriate side indicating the room's safety status so that it is visible in one of the top member's openings.

Thus, there has been summarized above, rather broadly, the more important features of the present invention in order that the detailed description that follows may be better understood and appreciated. There are, of course, additional features of the invention that will be described hereinafter and which will form the subject matter of any eventual claims to this invention.

### BRIEF DESCRIPTION OF THE DRAWINGS

FIG. 1 is a front view of the various elements that comprise a preferred embodiment of the present invention.

FIG. 2 is a more detailed front view of the middle, planar spacer member that comprises the embodiment shown in FIG. 1.

FIG. 3 is an exploded view of the various elements that comprise the embodiment shown in FIG. 1.

### DESCRIPTION OF THE PREFERRED EMBODIMENT

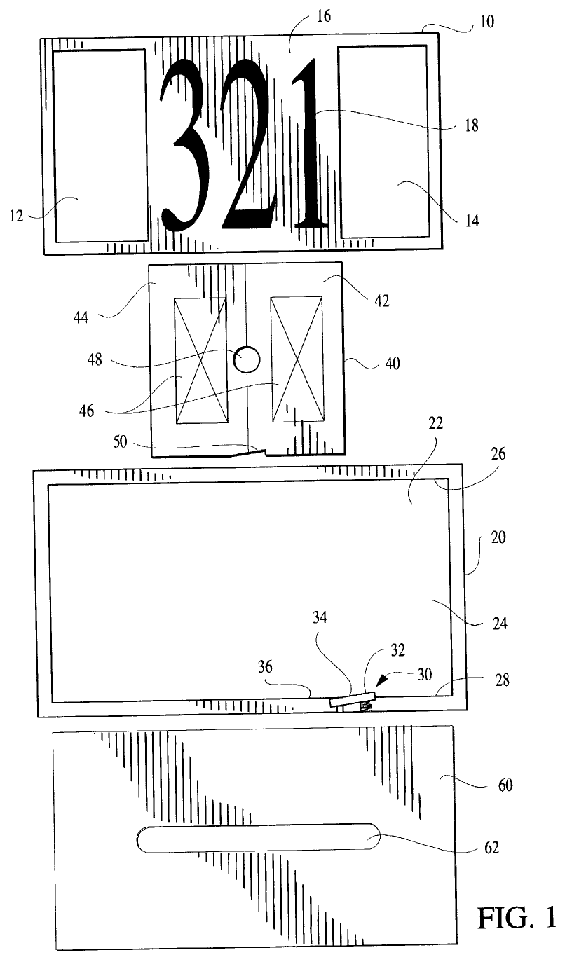

Referring now to the drawings wherein are shown preferred embodiments and wherein like reference numerals designate like elements throughout, there is shown in FIG. 1 a front view of the various elements that comprise a preferred embodiment of placard apparatus 1 of the present invention.

These are seen to include a top, planar member 10 having a right and a left edge with openings 12, 14 in the member proximate each of the edges. This member has a central section 16 separating the openings, with the central section having thereon indicia 18 which can be used to identify the room where the placard 1 is displayed.

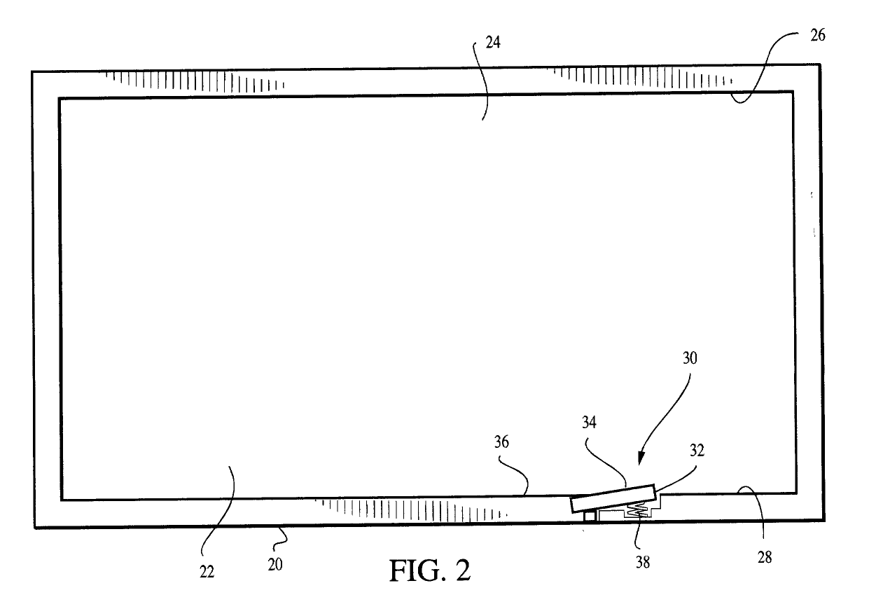

This placard apparatus 1 also includes a middle, planar spacer member 20 having outer edges that are configured to align with the outer edges of the top, planar member 10. This spacer member 20 has a large opening 22 in its central section 24 in which the top and bottom edges 26, 28 of this opening are parallel. In the bottom portion of this member 20 is latching mechanism 30 which consists of a latch member 32 that is pivotably fixed to the bottom portion of the member 20 such that is can be positioned in either of two positions. In its first position, the latch member's top edge 34 is parallel to the top portion 36 of its adjoining top edge. In its second position, the latch member's top edge 34 is rotated upward so that it extends above the top portion 36 of the adjoining top edge. A spring 38 is set beneath the latch member 32 and biases it so that it assumes it's second position. FIG. 2 provides a larger scale view of this member 20.

A slidably movable, planar, signage member 40 is configured so as to fit between the top and bottom parallel edges of the spacer member opening 22 and beneath the central section of the top, planar member 10. This signage member 40 has a right side 42 and a left side 44 portion. These portions 42, 44 contain indicia 46 that identifies the occupancy status and some aspect of the circumstances in the room where the placard apparatus is displayed. This signage member 40 also has in its central section an opening 48, or other means for allowing one to grasp this member 40 so that it can be pushed so that one side, 42 or 44, of the member is visible in one of the openings 12, 14 in the top member 10. The bottom portion of this member contains a notched portion 50 that is configured to mate with the top portion of the latch member 32 when it is in its second position.

Thus the latch mechanism is seen to lock the signage member into position when the signage member slides to the right so that its right side portion 42 is visible in the right side opening 14 of the top member. This begins to happen when the lower right corner of the signage member contacts the top of the latch member and forces it down against the bias of its underlying spring 38. When the signage member slides sufficiently far to the right so that its notched portion 50 passes above the top of the latch member, the spring 38 forces the top of the latch member upward so that it mates with the notched portion and locks the signage member in place.

A back, planar member 60 completes the major elements of the placard 1. It has outer edges that are configured to align with the outer edges of the top, planar member 10. A slotted opening 62 in this member provides access to the signage member's opening 48 which allows one to fix the position of the signage member in either its neutral position behind the central portion 16 of the top member 10 or to either side of it so that one portion, 42 or 44, of it is visible in one of the top member's two openings 12, 14.

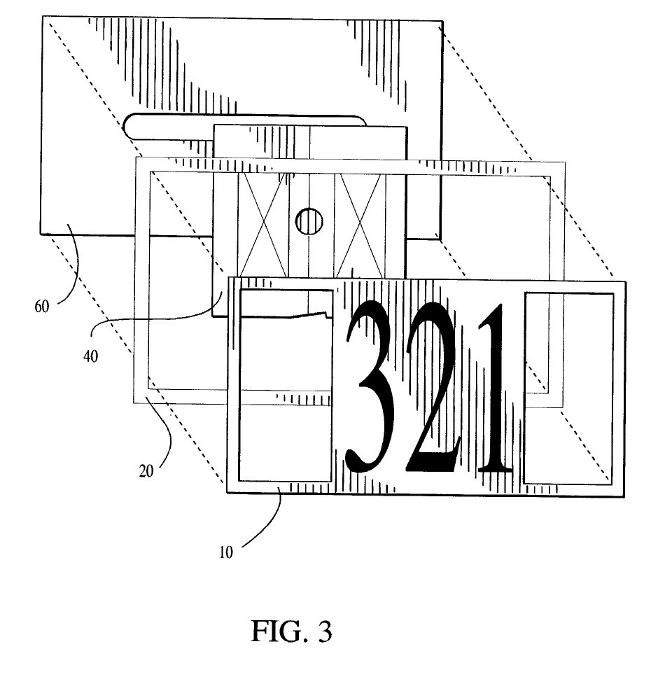

Means, such as fasteners at the corners, are used to hold the top 10, spacer 20 and back 50 members together and with the signage member 40 slidably sitting in the spacer's opening 22. FIG. 3 provides an exploded view of how these parts fit together.

A wide arrangement of materials can be used from which to make the device, depending on the relative physical characteristics (e.g., plastic to make the device more durable, cardboard to minimize the device's cost) desired for the device. For example, some of the earliest prototypes of the placard were made of 0.02-0.03 inch thick PVC.

Although the foregoing disclosure relates to a preferred embodiment of the invention, it is understood that these details have been given for the purposes of clarification only. Various changes and modifications of the invention will be apparent, to one having ordinary skill in the art, without departing from the spirit and scope of the present invention.

I claim:

1. A placard apparatus for display in the window of a room for visually informing persons outside of the room as to the status of the situation within the room, said placard apparatus comprising:
a top, planar member having a right and a left edge with an opening in said member proximate each of said edges, said member having a central section separating said openings, said central section having thereon identifying indicia,
a middle, planar spacer member having a central section containing an opening, said opening having a pair of edges, a portion of which are parallel,
a slidably movable, planar, signage member configured so as to fit between the pair of parallel edges of said spacer member opening and beneath the central section of said top, planar member, said signage member having a right side and a left side portion and wherein said side portions containing identifying indicia,
a back, planar member having a right and a left edge and a slotted opening extending between said edges, said back member being positioned behind said spacer and signage members,
means for fastening said members together so that said front members lies on top of said middle spacer member which lies on top of said back member and with said signage member lying within the cavity formed by the opening in said middle spacer member and the outer surfaces of said front and back members, and
wherein one may access said signage member through said back member slotted opening so as to slide said signage member sideways for the purpose of positioning either side portion of said signage member in the corresponding opening of said top member so that indicia on the exposed portion of said signage member can be seen through said opening.

2. A placard apparatus as recited in claim 1, wherein said spacer member having a latching means for ensuring that when said signage member is slid sideways it can be locked in a specified position within said spacer member.

3. A placard apparatus as recited in claim 1, wherein said signage member having an opening that is situated so as to align with said slotted opening in said back member when said signage member is slid sideways.

4. A placard apparatus as recited in claim 2, wherein said signage member having an opening that is situated so as to align with said slotted opening in said back member when said signage member is slid sideways.

5. A placard apparatus as recited in claim 1, wherein said indicia is to inform responding emergency personnel as to the occupancy status and circumstances within the room displaying said placard.

6. A placard apparatus as recited in claim 2, wherein said indicia is to inform responding emergency personnel as to the occupancy status and circumstances within the room displaying said placard.

7. A placard apparatus as recited in claim 3, wherein said indicia is to inform responding emergency personnel as to the occupancy status and circumstances within the room displaying said placard.

8. A placard apparatus as recited in claim 4, wherein said indicia is to inform responding emergency personnel as to the occupancy status and circumstances within the room displaying said placard.

9. A placard apparatus as recited in claim 1, wherein said indicia on said top member is information that identifies the room in whose window said placard is being displayed.

10. A placard apparatus as recited in claim 2, wherein said indicia on said top member is information that identifies the room in whose window said placard is being displayed.

11. A placard apparatus as recited in claim 3, wherein said indicia on said top member is information that identifies the room in whose window said placard is being displayed.

12. A placard apparatus as recited in claim 4, wherein said indicia on said top member is information that identifies the room in whose window said placard is being displayed.

13. A placard apparatus as recited in claim 9, wherein said indicia on one side of said signage member informs said emergency personnel that the situation within said room is safe and the indicia on the other side of the member informs said emergency personnel that the situation within said room is not safe and that immediate assistance is needed.

14. A placard apparatus as recited in claim 10, wherein said indicia on one side of said signage member informs said emergency personnel that the situation within said room is safe and the indicia on the other side of the member informs said emergency personnel that the situation within said room is not safe and that immediate assistance is needed.

15. A placard apparatus as recited in claim 11, wherein said indicia on one side of said signage member informs said emergency personnel that the situation within said room is safe and the indicia on the other side of the member informs said emergency personnel that the situation within said room is not safe and that immediate assistance is needed.

16. A placard apparatus as recited in claim 12, wherein said indicia on one side of said signage member informs said emergency personnel that the situation within said room is safe and the indicia on the other side of the member informs said emergency personnel that the situation within said room is not safe and that immediate assistance is needed.

17. A method for informing responding emergency personnel as to the occupancy status and situation with a room, said method comprising the steps of:
displaying a placard within a window of said room that is viewable by said responding emergency personnel,
constructing said placard so that it comprises: (a) a top, planar member having a right and a left edge with an opening in said member proximate each of said edges, said member having a central section separating said openings, said central section having thereon identifying indicia, (b) a middle, planar spacer member having a central section containing an opening, said opening having a pair of edges, a portion of which are parallel, (c) a slidably movable, planar, signage member configured so as to fit between the pair of parallel edges of said spacer member opening and beneath the central section of said top, planar member, said signage member having a right side and a left side portion and wherein said side portions containing identifying indicia, (d) a back, planar member having a right and a left edge and a slotted opening extending between said edges, said back member being positioned behind said spacer and signage members, (e) means for fastening said members together so that said front members lies on top of said middle spacer member which lies on top of said back member and with said signage member lying within the cavity formed by the opening in said middle spacer member and the outer surfaces of said front and back members, and
sliding said signage member sideways for the purpose of positioning either side portion of said signage member in the corresponding opening of said top member so that indicia on the exposed portion of said signage member can be seen through said opening.
